(19) United States
(12) Patent Application Publication
(10) Pub. No.: US 2011/0272132 A1
(43) Pub. Date: Nov. 10, 2011

(54) ARRANGEMENT AND METHOD FOR HEATING DRINKING WATER FOR ONE CONSUMPTION POINT OR TAPPING POINT

(75) Inventors: CHRISTIAN KOCH, Wendisch Evern (DE); JAKOB MEIERLE, Reppenstedt (DE)

(73) Assignee: Gerdes OHG, Lueneburg (DE)

(21) Appl. No.: 12/774,444

(22) Filed: May 5, 2010

(51) Int. Cl. G05D 23/00; F24H 1/18; F28D 15/00

(52) U.S. Cl. 165/287; 165/104.31; 165/47

(57) ABSTRACT

The invention concerns an arrangement for heating drinking water for at least one consumption point or tapping point, comprising a fresh water station having an inlet for cold drinking water, a heating device for heating a heat-transfer medium, a pump for circulation of the medium heated by the heating device through the fresh water station, a heat exchanger within the fresh water station for transfer of the heat generated by the heating device to the cold drinking water, and an instantaneous water heater arranged behind the fresh water station in the direction of flow of the already heated drinking water, having a control and regulating unit for controlling and/or regulating the temperature of the drinking water, which is distinguished in that between the instantaneous water heater and the fresh water station is a direct control and/or regulating signal link for nominal value adjustment of the temperature of the drinking water in the fresh water station by the instantaneous water heater. Furthermore the invention concerns a corresponding method.

### BACKGROUND

The invention concerns an arrangement for heating drinking water for at least one consumption point or tapping point, comprising a fresh water station having an inlet for cold drinking water T_{K}, a heating device for heating a heat-transfer medium, a pump for circulation of the medium heated by the heating device through the fresh water station, a heat exchanger within the fresh water station for transfer of the heat generated by the heating device to the cold drinking water T_{K}, and an instantaneous water heater arranged behind the fresh water station in the direction of flow of the already heated drinking water T_{W}, having a control and regulating unit for controlling and/or regulating the temperature of the drinking water. Furthermore the invention concerns a method for heating drinking water for at least one consumption point or tapping point, comprising the steps of: delivering cold drinking water T_{K} to a fresh water station, heating a heat-transfer medium by means of a heating device, circulating the heated medium through the fresh water station by means of a pump, transferring the heat to the drinking water T_{K} by means of a heat exchanger, and controlling and/or regulating the drinking water temperature by means of an instantaneous water heater.

Such arrangements and methods are used both in private households and in commercial or industrial facilities as well as in all other areas in which drinking water, which can also be referred to as water for domestic use or fresh water, is needed at a desired water temperature. Purely by way of example, the consumption point or tapping point is a shower which is to deliver water at 40° C. at the demand/wish of the user. It is known that the drinking water is heated to a desired temperature by a heating device, namely e.g. a solar storage tank as a primary heat source.

Naturally, the heating device can also be a gas or oil heating system or any other known heat source. In case of a lack of efficiency of the heating device, by the example of the solar storage tank in times of low or absent incident solar radiation, the temperature in the solar storage tank drops below the desired temperature value, so that so-called top-up heating systems which deliver the missing energy for achieving the desired heating are used. This top-up heating is in practice frequently achieved by a central heating system running on fossil fuels. These systems heat the water supply in the solar storage tank to the nominal value temperature. However, these systems have proved uneconomical because it is always the whole tank contents or parts of the tank contents on supply that are heated to the nominal value temperature, on account of which the use of instantaneous water heaters is preferable for topping up, as instantaneous water heaters only heat the drinking water which is actually drawn off to the nominal value. Therefore the known arrangements and methods with an instantaneous water heater as a top-up heating system form the basis. This is achieved by the instantaneous water heater which is mounted behind the fresh water station and which carries out immediate heating of the drinking water to the nominal value and so provides the required temperature.

German patent document DE 28 21 793 discloses an apparatus for hot water heating in residential buildings, industrial works and the like. The apparatus described in this document comprises a solar thermal heating device by means of which the drinking water in the fresh water station is heated and then discharged direct and/or via an instantaneous water heater to a mixer tap. The fresh water station is set at a fixed temperature value. As soon as the temperature in the fresh water station drops below the set temperature, the instantaneous water heater begins working. For this purpose the instantaneous water heater receives a corresponding signal from the fresh water station. If the set temperature in the fresh water station is higher than the desired temperature, the excessively hot drinking water flowing from the fresh water station must be cooled by adding cold drinking water.

This arrangement has several drawbacks. Firstly, this kind of temperature control/regulation is uneconomical, because in some applications heated water must be cooled again. Secondly, the known arrangement requires additional circulation pipes, e.g. for delivering cold drinking water to the mixer tap, which causes elevated space and assembly requirements and means higher costs. A further big disadvantage lies in that the drinking water in the fresh water station, which as a rule contains a water storage unit, possibly stands for a long time and is kept at an elevated temperature level. This means that there is a risk of the formation of germs, e.g. legionella, in the fresh water station or in the water storage units of the fresh water stations. This problem can be reduced only by regularly heating the drinking water in the water storage unit to over approximately 60° C., even without demand, in order to effectively suppress or eliminate the germs, bacteria, etc. This type of control and/or regulation also leads to so-called standing losses. This means that heat energy is continuously discharged to the environment unused.

### SUMMARY

It is therefore an object of the invention to provide a compact and simple apparatus for cost- and energy-efficient heating of drinking water for at least one point of consumption or tap. Furthermore it is the object of the present invention to propose a corresponding method.

In an embodiment of the invention there is provide an apparatus of the kind mentioned hereinbefore wherein between the instantaneous water heater and the fresh water station is a direct control and/or regulating signal link for nominal value adjustment of the temperature of the drinking water in the fresh water station by the instantaneous water heater. As a result, in a surprisingly simple and effective manner a compact arrangement is provided, by means of which the drinking water T_{W} drawn off from the consumption point or tapping point has the desired temperature. With the design according to the invention, additional circulation pipes can be dispensed with, which simplifies the construction and assembly and so saves costs. Due to direct control of the fresh water station via the instantaneous water heater, a high energy efficiency is achieved, as the drinking water is actually heated only when it is required and in the quantity which is required.

In a further embodiment, the heating device for heating the heat-transfer medium has a primary heat source with a storage unit for the medium, wherein the storage unit, the pump and the pipe for supplying the heat-transfer medium to the fresh water station and the pipe for discharging the heat-transfer medium from the fresh water station form a closed circuit for the medium. Due to this closed system, the possibility of the formation of germs e.g. legionella is virtually excluded, as the drinking water T_{K} delivered to the fresh water station and the drinking water T_{W} flowing from the fresh water station is not stored, but flows through the fresh water station without contact with the stored medium. In the event that drinking water is not required, only unheated drinking water T_{K} which does not tend to form germs is to be found in the fresh water station or in the supply pipe. A further advantage lies in that the medium stored in the storage unit does not have to be further heated, because the formation of germs inside the storage unit for the drinking water is insignificant.

The instantaneous water heater and the fresh water station may be optionally designed to be spatially separate or form a structural unit. Both embodiments have advantages. A spatially separate arrangement can, adapted to the respective local circumstances, be particularly easy to install. The integral design of fresh water station and instantaneous water heater is particularly compact.

In an embodiment of the invention the instantaneous water heater may be arranged in the spatial vicinity of the consumption point or tapping point. The term “spatial vicinity” describes the direct positioning of the instantaneous water heater at the consumption point or tapping point, so that the conduction losses are kept small. Concretely, the instantaneous water heater can be installed e.g. in the shower cubicle near the shut-off valve of the consumption point or tapping point. “Spatial vicinity” does however include e.g. an arrangement of the instantaneous water heater under a wash basin as well.

According to another aspect of the invention there is provided a method mentioned hereinbefore wherein the nominal value adjustment of the temperature of the drinking water in the fresh water station is effected by the instantaneous water heater. The resulting advantages have already been described in connection with the apparatus according to the invention, so that reference is made to the appropriate passages to avoid repetition.

Further appropriate and/or advantageous features and method steps are apparent from the subsidiary claims and the description.

### BRIEF DESCRIPTION OF THE DRAWINGS

An embodiment as well as the principle of the method are described in more detail with the aid of the attached drawing.

FIG. 1 is a schematic view of an arrangement according to the invention.

### DETAILED DESCRIPTION

The arrangement shown in the drawing and described below is used to further heat drinking water already heated by a solar thermal heating source. Naturally, the assembly can also co-operate with other primary heating sources, such as e.g. heat pumps, geothermal energy, or heating systems running on fossil fuels.

The arrangement 10 for heating drinking water for at least one consumption point or tapping point 11 comprises a fresh water station 12 with an inlet 13 for unheated, cold drinking water T_{K}, a heating device 14 for heating a heat-transfer medium M, a pump 15 for circulation of the medium heated by the heating device 14 through the fresh water station 12, a heat exchanger 16 within the fresh water station 12 for transfer of the heat provided by the heating device 14 to the cold drinking water T_{K}, and an instantaneous water heater 17 which is mounted behind the fresh water station 12 in the direction of flow of the already heated drinking water T_{W} and which has a control and/or regulating unit for controlling and/or regulating the temperature of the drinking water. But the arrangement 10 can also have more than one consumption point or tapping point 11. For simplicity's sake, however, the invention is described with reference to one consumption point or tapping point 11.

The instantaneous water heater 17 is mounted between the fresh water station 12 and the consumption point or tapping point 11, and connected both to the fresh water station 12 and to the consumption point or tapping point 11 by at least one pipe 18 (conducts the drinking water T_{W}) or 19. Between the instantaneous water heater 17 and the consumption point or tapping point 11 is arranged a shut-off valve (not shown explicitly) for releasing or blocking the stream of drinking water. Alternatively, the or each shut-off valve can be arranged in a different position, particularly also in the region of the pipe 18. Between the instantaneous water heater 17 and the fresh water station 12 there is also a direct control and/or regulating signal link 28 for set-point adjustment of the temperature of the drinking water in the fresh water station 12 by the instantaneous water heater 17. To put it another way, the fresh water station 12 can be controlled and/or regulated by means of the instantaneous water heater 17.

The heating device 14 for heating the heat-transfer medium M optionally has a primary heat source 20 with a storage unit 21 for the medium M. Preferably a solar thermal heating device is provided as the heat source 20. Naturally conventional heating systems that run on fossil fuels, heat pumps, geothermal energy or other alternative or renewable energy sources can be used as the heat source 20. The storage unit 21 is usually a tank. But the storage unit 21 can also be designed as a pipe system or a vessel which holds the medium M in some other way. The medium M can be solid, gaseous and preferably liquid. In the embodiment described and shown the medium M is water. But other media are possible as well.

The storage unit 21, the pump 15 and the pipe 22 for supplying the heat-transfer medium M to the fresh water station 12 and the pipe 23 for discharging the heat-transfer medium M from the fresh water station 12 form a closed circuit or a closed system 24 for the medium M. To put it another way, the medium M circulates through the storage unit 21, the supply pipe 22, the discharge pipe 23 and the fresh water station 12 without contact with the drinking water. In the embodiment described, the pump 15 is preferably arranged in the fresh water station 12. But the pump 15 can also be arranged or positioned in the storage unit 21 or in the supply pipe 22 and/or the discharge pipe 23.

Within the storage unit 21 can optionally be arranged further heat exchangers 25. In the embodiment described the storage unit 21 is connected to the heat source 20 by a first pipe 26. Via this pipe, a heating medium is delivered to the heat source 20. The heating medium which is heated within the heat source 20 is returned to the storage unit 21 via a second pipe 27. The connections of the pipes 26, 27 are preferably formed on the heat exchanger 25. Other possible ways of connection between the heat source 20 and the storage unit 21, particularly also without a heat exchanger 25, are possible as well.

The control and/or regulating signal link 28 between the instantaneous water heater 17 and the fresh water station 12 can optionally be a cable link, a network and/or a wireless link. The type of signal link essentially depends on the spatial circumstances and the wishes of the users, and can be implemented within the scope of ordinary designs. The instantaneous water heater 17 itself can be operated directly via at least one switching element on the instantaneous water heater 17 or also e.g. by wireless control. In the embodiment described the instantaneous water heater 17 and the fresh water station 12 are separate units. To put it another way, the instantaneous water heater 17 is arranged spatially separately from the fresh water station 12. In such a case both the instantaneous water heater 17 and the fresh water station 12 have their own control and/or regulating unit. In the instantaneous water heater 17 the control and/or regulating unit is preferably constructed and designed to control and/or regulate the temperature of the drinking water. The control and/or regulating unit of the fresh water station 12 is preferably constructed and designed to control and/or regulate the speed of rotation of the pump 15.

In one embodiment, not shown, the instantaneous water heater 17 and the fresh water station 12 can also form a structural unit. For this purpose the instantaneous water heater 17 and the fresh water station 12 can be combined one above the other, one below the other, one beside the other or in any other integrated way. In this case it may be particularly preferable to provide a common control and/or regulating unit which undertakes both control and/or regulation of the instantaneous water heater 17 and control and/or regulation of the fresh water station 12.

In the embodiment shown the consumption point or tapping point 11 is a shower. The instantaneous water heater 17 is arranged in the spatial vicinity of the consumption point or tapping point 11. But the distance between the instantaneous water heater 17 and the consumption point or tapping point 11 can also be greater, particularly if the instantaneous water heater 17 and the fresh water station 12 form a structural unit. But any other tap, namely e.g. a water tap, a connection for a dishwasher, an industrial tapping point, etc. is possible as well. Preferably the arrangement 10 is completely uncoupled from the actual heating system.

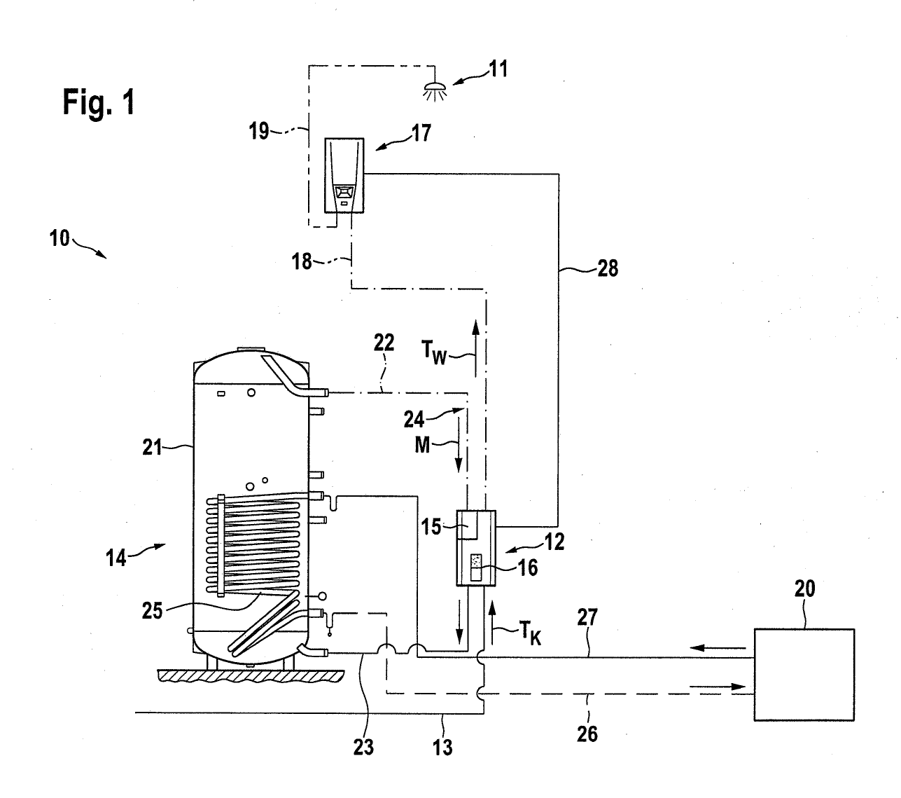

Below, the principle of the method is described in more detail with the aid of FIG. 1, wherein purely by way of example water is to be drawn off at 40° C. from the consumption point or tapping point 11 as the shower. The nominal value temperature of 40° C. is entered by the user at the instantaneous water heater 17 directly or by remote control. The instantaneous water heater 17 sends a corresponding signal to the fresh water station 12. In other words, the instantaneous water heater 17 adjusts the nominal value temperature of the drinking water in the fresh water station 12 via the control and/or regulating signal link. Signal transmission can be wired, via networks or by wireless.

First of all cold drinking water T_{K} is conducted via the input 13 into the fresh water station 12. The cold drinking water T_{K} is heated to the nominal value temperature in the fresh water station 12 by means of the heat exchanger 16, and then flows through the pipe 18 to or into the instantaneous water heater 17. For heating the cold drinking water T_{K}, medium M which is in the storage unit 21, preferably water, is or was heated by means of the heat source 20 and transferred from the heat exchanger 25 to the water. The water heated in this way circulates by means of the pump 15 in the closed system 24 and in the process flows through the fresh water station 12, past the cold drinking water T_{K}, so to speak, as a result of which the latter is heated on flowing through the fresh water station 12 over the heat exchanger 16. Due to control/regulation of the speed of rotation of the pump 15 by the fresh water station 12 upon the signal of the instantaneous water heater 17, the required heat is transferred to the drinking water T_{K}, which leaves the fresh water station 12 as heated drinking water T_{W}. When the shut-off valve at the shower is opened, the heated drinking water T_{W} flows at the desired temperature (nominal value temperature) out of the fresh water station 12 through the instantaneous water heater 17 out of the shower. As long as the temperature at the input of the instantaneous water heater 17 is below the nominal value temperature, the instantaneous water heater 17 still carries on heating the drinking water T_{W} to the nominal value temperature. As soon as the nominal value temperature is reached at the input of the instantaneous water heater 17, further heating is suspended.

If the heat generated by the heat source 20 is not sufficient to heat the drinking water T_{K} to the nominal value temperature, then after the temperature at which the drinking water T_{W} enters the instantaneous water heater 17 has been determined, the instantaneous water heater 17 heats the already (pre-)heated drinking water T_{W} to the nominal value temperature. The eventuality of drinking water T_{W} arriving at the instantaneous water heater 17 at a temperature which is above the nominal value temperature is excluded, as the fresh water station 12 is already set to the nominal value temperature by the instantaneous water heater 17 and if necessary the speed of rotation of the pump 15 is reduced.

As already mentioned, the medium which transfers the heat is heated by a primary heat source 20 and stored in the storage unit 21. Preferably a solar thermal heating device is provided as the primary heat source 20. But heat pumps or geothermal energy are also particularly suitable. Naturally fossil fuels such as gas or oil can also be used to generate the heat. District or local heating is also suitable as the heat source 20. Alternatively there is also the possibility that instead of water as the heat-transfer medium M, a solid medium is heated by the primary heat source 20 and transfers the heat to the drinking water flowing through the fresh water station 12. The medium M can in a further particular embodiment be formed e.g. by a phase change medium, e.g. paraffin, as described in DE 10 2006 057 845 A1. In that case a further heat exchanger 25 is needed for this purpose in the storage unit 21 within the closed system 24. In the event that no instantaneous water heater 17 is assembled, the nominal value adjustment for the temperature of the drinking water can also be transmitted directly to the fresh water station 12, for example by wireless, cable or network.

As described above, the arrangement 10 is preferably uncoupled from the actual central heating system. This means that hot water heating and space heating are two different systems. Naturally the system for hot water heating can also be incorporated in the space heating system. Also, combinations of the above-mentioned primary heat sources 20 and connection to various positions other than e.g. directly to the fresh water station 12, directly to the storage unit 21, etc., are possible. In a further embodiment according to the invention, the fresh water station 12 can also be constructed from discrete components such as e.g. pump, heat exchanger, throughflow sensors, temperature sensors and a control means. In other words, the fresh water station 12 does not have to be formed as a unit.

Due to the arrangement 10 according to the invention and the resulting demand-driven heating of the drinking water which is actually drawn off, heat losses of the storage unit 21 can be avoided. Due to the combination of the fresh water station 12 with an instantaneous water heater 17, the whole of the storage contents of the storage unit 21 can be used to heat the drinking water.

1. An arrangement to heat drinking water for at least one consumption point or tapping point, comprising:
a fresh water station including an inlet to admit cold drinking water;
a heating device to heat a heat-transfer medium M;
a pump to circulate the medium heated by the heating device through the fresh water station;
a heat exchanger arranged within the fresh water station to transfer heat generated by the heating device to the cold drinking water;
an instantaneous water heater arranged downstream of the fresh water station in the direction of flow of the drinking water already heated by the heat exchanger in the fresh water station, the instantaneous water heater having a control and regulating unit for controlling and/or regulating the temperature of the drinking water; and
a direct control and/or regulating signal link between the instantaneous water heater and the fresh water station to adjust a nominal value of the temperature of the drinking water in the fresh water station under control of the control and regulating unit in the instantaneous water heater.

2. The arrangement according to claim 1, wherein the heating device has a primary heat source and a storage unit for the medium.

3. The arrangement according to claim 2, further comprising a first pipe to supply the heat transfer medium from the storage unit to the fresh water station and a second pipe to discharge the heat transfer medium from the fresh water station to the storage unit, wherein the storage unit, the pump, the first pipe and the second pipe form a closed circuit for the heat transfer medium.

4. The arrangement according to claim 2, wherein the pump is assigned to one of the storage unit or the fresh water station.

5. The arrangement according to claim 1, wherein the control and/or regulating signal link between the instantaneous flow heater and the fresh water station is at least one of a cable link, a network and a wireless link.

6. The arrangement according claim 1, wherein the instantaneous water heater and the fresh water station are one of spatially separate or a structural unit.

7. The arrangement according to claim 2, further comprising at least one additional heat exchanger assigned to the storage unit.

8. The arrangement according to claim 1, wherein the instantaneous water heater is arranged in a spatial vicinity of the consumption point or tapping point.

9. A method to heat drinking water for at least one consumption point or tapping point, comprising the steps of:
delivering cold drinking water to a fresh water station;
heating a heat-transfer medium by a heating device;
circulating the heated medium through the fresh water station by a pump
transferring the heat to the drinking water by a heat exchanger; and
controlling and/or regulating a temperature of the drinking water by an instantaneous water heater, to effect a nominal value adjustment of the temperature of the drinking water in the fresh water station.

10. The method according to claim 9, wherein the controlling and/or regulating includes controlling and/or regulating the speed of rotation of the pump by the fresh water station on the basis of the nominal value.

11. The method according claim 9, wherein the heating step includes heating the heat-transfer medium by a primary heat source and storing the heated heat-transfer medium in a storage unit.

12. The method according claim 9, further including circulating the heat-transfer medium in a closed circuit.

13. The method according to claim 9, further including measuring the input temperature of the already heated drinking water at an input of the instantaneous water heater and determining the nominal value adjustment based on the measured input temperature.

14. The method according to claim 9, wherein the controlling and/or regulating step includes transmitting the control and/or regulating signals between the instantaneous water heater and the fresh water station via at least one of a direct cable link, a network and a wireless link.

15. The method according to claim 9, further including operating the instantaneous water heater by at least one of a wireless remote control, a cable and a network.
